(19) United States
(12) Patent Application Publication
(10) Pub. No.: US 2013/0143174 A1
(43) Pub. Date: Jun. 6, 2013

(54) ILLUMINATED SCALER HAND PIECE IN A VETERINARY DENTAL DEVICE

(71) Applicants: Charles F. Betyeman, Milton, DE (US); Dennis Karol, Rehoboth Beach, DE (US)

(72) Inventors: Charles F. Betyeman, Milton, DE (US); Dennis Karol, Rehoboth Beach, DE (US)

(21) Appl. No.: 13/692,895

(22) Filed: Dec. 3, 2012

Related U.S. Application Data
(60) Provisional application No. 61/566,426, filed on Dec. 2, 2011.

(51) Int. Cl. A61D 5/00

(52) U.S. Cl. CPC A61D 5/00
USPC 433/1

(57) ABSTRACT

A light is built directly into a scaler hand piece and adds little or no additional bulk or weight thereto. The light allows a Veterinarian or Technician to directly illuminate an area to be worked, with the hand piece providing a bright, clear source of light with no shadows. The light can be emitted from a light tube disposed along a scaler insert device, providing emission of light near the tip of the scaler insert. The light can be easily placed directly into a patient's oral cavity. With the light built into the scaler, it does not add any additional bulk and the scaler hand piece and light source can be easily directed to the area that requires work. The light source, being mounted directly into the scaler hand piece, is more cost efficient compared to purchasing a separate external light source to be affixed to the scaler hand piece.

### CROSS-REFERENCE TO RELATED APPLICATION

This application claims the benefit of priority of U.S. provisional application No. 61/566,426, filed Dec. 2, 2011, the contents of which are herein incorporated by reference.

### BACKGROUND OF THE INVENTION

The present invention relates to veterinary devices and, more particularly, to an illuminated scaler hand piece in a veterinary dental device.

Conventional scaler hand pieces provide no illumination into the patient's oral cavity. This makes it difficult for the Veterinarian or Technician to clearly see all of the built up calculus that is to be removed.

Large overhead lights in exam rooms do not provide a “pinpoint” stream of illumination into the area to be worked. Also, the Veterinarian or Technician's hands may cast shadows when a light source is located outside of the oral cavity, making it difficult and time-consuming to complete the scaling procedure.

Currently, there are separate light sources that can be externally affixed to the scaler hand piece, but these increase the cost of the dental device, can be unwieldy and are bulky and difficult to maneuver and manipulate inside of the patient's oral cavity.

As can be seen, there is a need for an improved scaler hand piece that can provide adequate light directly to the area to be worked.

### SUMMARY OF THE INVENTION

In one aspect of the present invention, a scaler hand piece comprises a body; a scaler insert device attached to a first end of the body; a light tube extending from the first end of the body along a length of the scaler insert device; and a light operable to provide directed illumination from the light tube when the scaler hand piece is powered on.

In another aspect of the present invention, a scaler hand piece comprises a body; a scaler insert device attached to a first end of the body; an end cap on a second, opposite end of the body; a light tube extending from the first end of the body along over half of a length of the scaler insert device; and a light operable to provide directed illumination from the light tube when the scaler hand piece is turned on, wherein the directed illumination is directed at a distal end of the scaler insert device.

These and other features, aspects and advantages of the present invention will become better understood with reference to the following drawings, description and claims.

### BRIEF DESCRIPTION OF THE DRAWINGS

FIG. 1 is a perspective view of an illuminated scaler hand piece according to an exemplary embodiment of the present invention;

FIG. 2 is a detailed perspective view of the body, scaler insert device and light tube of the illuminated scaler hand piece of FIG. 1;

FIG. 3 is a side view of the illuminated scaler hand piece of FIG. 1; and

FIG. 4 is a front view of the illuminated scaler hand piece of FIG. 1;

FIG. 5 is an electrical schematic diagram showing an exemplary electrical configuration of the scaler hand piece of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a light source built directly into a scaler hand piece that adds little or no additional bulk or weight thereto. The light source allows a Veterinarian or Technician to focus the light directly on an area to be worked, with the hand piece having a bright, clear source of light with no shadows. The light can be emitted from a light tube disposed along a scaler insert device, providing emission of light near the tip of the scaler insert. The light can be easily placed directly into a patient's oral cavity. With the light built into the scaler, it does not add any additional bulk and the scaler hand piece and light source can be easily directed by the Veterinarian or Technician to the area that requires work. The light source, being mounted directly into the scaler hand piece, is more cost efficient for the customer than purchasing a separate external light source to be affixed to the scaler hand piece or purchasing non-conventional, proprietary inserts.

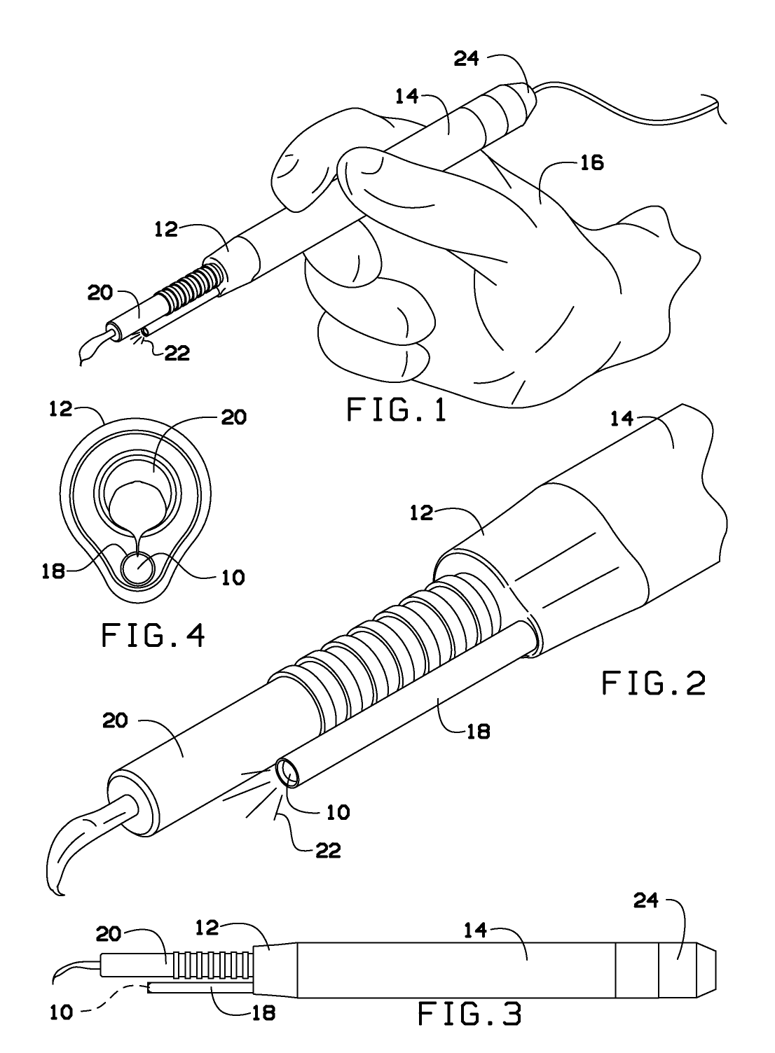

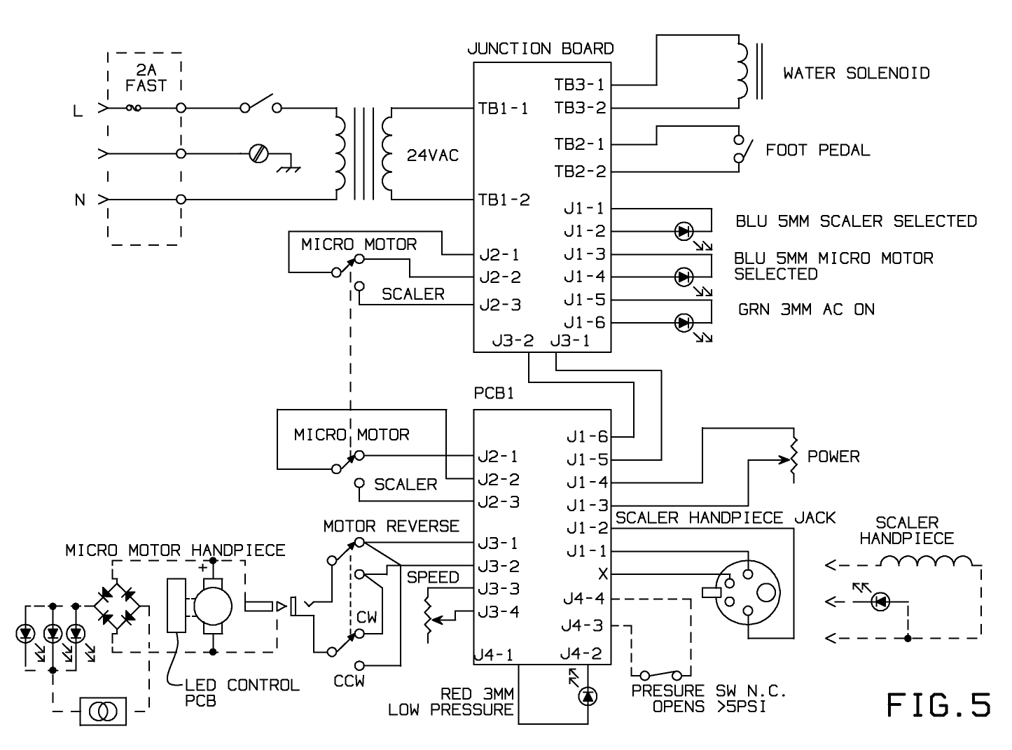

Referring now to FIGS. 1 through 5, a scaler hand piece can include a body 12 and a sleeve 14. A user 16 can grasp the sleeve 14, for example, to operate the scaler hand piece. An endcap 24 can be disposed on one end of the sleeve 14.

A light tube 18 can extend from the body 12 and extend along at least a portion of a scaler insert device 20. The light tube 18 can include a light 10 operable to provide illumination 22 directed at the tip of the scaler insert device 20, thereby illuminating an area being worked by a Veterinarian or Technician. Typically, the light tube 18 extends over more than half of the length of the scaler insert device 20.

The light 10 can be made in various designs. Typically, a light emitting diode (LED) is used, but other light sources are also contemplated within the scope of the present invention. For example, the light 10 could be an incandescent light, a halogen lamp, a fiber optic light source, or the like.

The light 10 can be wired such that when the scaler hand piece is powered on, the light 10 illuminates. The power to the light 10 can be constant to provide even and stable illumination from the light 10.

The illumination 22 provided from the light 10 can be pinpoint directed to the area being worked and eliminate any shadows such as those cast from the Veterinarian or Technician's hands and body when they use large overhead exam room lights.

When the scaler hand piece is activated, the incorporated light 10 (such as a high intensity LED) is illuminated, allowing Veterinarians and Technicians to have a directed light aimed exactly in the area in which they are working. Since the light source is directly built into the scaler hand piece and generates illumination merely by turning on the unit, no training is necessary for the operator. The Veterinarian or Technician performs the dental procedure that he/she has been trained to do, but now has a clear stream of light illuminating the area in which he/she works.

While described above as a scaler hand piece for veterinary dental applications, the present invention can be adapted for use in nearly any low voltage power hand tool. A battery-operated “snap-on” version could be used with non-powered hand tools.

It should be understood, of course, that the foregoing relates to exemplary embodiments of the invention and that modifications may be made without departing from the spirit and scope of the invention as set forth in the following claims.

What is claimed is:

1. A scaler hand piece comprising:
a body;
a scaler insert device attached to a first end of the body;
a light tube extending from the first end of the body along a length of the scaler insert device; and
a light operable to provide directed illumination from the light tube when the scaler hand piece is powered on.

2. The scaler hand piece of claim 1, wherein the length is at least half way along the length of the scaler insert device.

3. The scaler hand piece of claim 1, wherein the light is a light emitting diode (LED).

4. The scaler hand piece of claim 1, wherein the light is an incandescent light.

5. The scaler hand piece of claim 1, wherein the light is a fiber optic light.

6. The scaler hand piece of claim 1, further comprising an end cap on a second, opposite end of the body.

7. The scaler hand piece of claim 1, further comprising a sleeve disposed over the body.

8. The scaler hand piece of claim 1, wherein the directed illumination is directed at a distal end of the scaler insert device.

9. The scaler hand piece of claim 1, wherein the light receives power from power supplied to the scaler hand piece.

10. A scaler hand piece comprising:
a body;
a scaler insert device attached to a first end of the body;
an end cap on a second, opposite end of the body;
a light tube extending from the first end of the body along over half of a length of the scaler insert device; and
a light operable to provide directed illumination from the light tube when the scaler hand piece is turned on, wherein
the directed illumination is directed at a distal end of the scaler insert device.

11. The scaler hand piece of claim 10, wherein the light is a light emitting diode (LED).

12. The scaler hand piece of claim 10, wherein the light is an incandescent light.

13. The scaler hand piece of claim 10, wherein the light is a fiber optic light.

14. The scaler hand piece of claim 10, wherein the light receives power from power supplied to the scaler hand piece.
